(19) United States
(12) Patent Application Publication
(10) Pub. No.: US 2024/0155708 A1
(43) Pub. Date: May 9, 2024

(54) METHOD AND DEVICE FOR PRODUCING A COMMUNICATION CHANNEL

(71) Applicant: Rene KIESSIG, Bingen (DE)

(72) Inventor: Rene KIESSIG, Bingen (DE)

(21) Appl. No.: 18/416,334

(22) Filed: Jan. 18, 2024

Related U.S. Application Data
(63) Continuation of application No. PCT/EP2022/079097, filed on Oct. 19, 2022.

(30) Foreign Application Priority Data
Nov. 2, 2021 (EP) 21206065.1

(51) Int. Cl. H04W 76/11

(52) U.S. Cl. CPC H04W 76/11

(57) ABSTRACT

A method configures a mobile terminal of a user in a semi-automated device of a communication channel. It is possible by means of the proposed method to preselect communication partners with minimal technical complexity as a function of hardware parameters such as screen size and camera resolution and to produce a communication channel. The technical complexity in terms of computing capacity, storage capacity and storage performance is reduced compared with known methods such that the proposed method can be carried out for example on a smartphone. Also provided is a correspondingly configured device. Also provided is a computer program product with control commands which implement the disclosed method and operate the disclosed device and arrangement.

### CROSS REFERENCE TO RELATED APPLICATIONS

This application is a continuation of International Application No. PCT/EP2022/079097, filed on Oct. 19, 2022, which takes priority from European Patent Application No. 21206065.1, filed Nov. 2, 2021, the contents of each of which are incorporated by reference herein.

### TECHNICAL FIELD

The present invention relates to a method of producing a communication channel by configuring a user's mobile device in a semi-automated setup. By means of the proposed method, it is possible to preselect communication partners and establish a communication channel with little technical effort depending on the present hardware parameters, such as screen size and camera resolution. The technical effort in terms of computing capacity, memory capacity and memory performance is reduced compared to known methods to the extent that the proposed invention can be implemented on a smartphone. The invention is also directed to a device that has been configured accordingly. Furthermore, a computer program product with control instructions is proposed, which implements the proposed method or operates the proposed device and arrangement.

### BACKGROUND

DE 10 2015 214 744 B4 discloses a head-up display system comprised of a display unit which is made up of a projection unit configured to be positioned adjacent to a windshield, the display unit further comprises a display screen and a control element.

DE 11 2014 005 165 T5 refers to different levels in the panoramic view that comprise performance of an interactive digital media representation with multiple views.

The prior art shows surveillance systems which can monitor large events by aiming cameras at, for example, the side of a building. Cameras are mounted on the ceiling in such a way that they can view the area being monitored. This means that according to the prior art, a specific area can be monitored regardless of the number of people present. This unrestricted number of people provides larger amounts of data, and assumes that sufficient computing capacity is available. Mobile devices, in particular, tend not to have the necessary computing capacity.

The prior art also assumes that surveillance cameras do not carry out any data processing themselves, but rather transmit the captured image data to a remote computing unit. This remote computing unit will typically have extensive hardware capacities. Data is transmitted to at least one server, which then takes over the data processing. In this respect, surveillance cameras are typically passive image sensors that provide image data according to their viewing angle. Active control units are located at a distance from these cameras and thus, surveillance personnel must manually enter an angle of vision and a zoom factor into the camera, which is then implemented remotely. The prior art does not show data capture and processing in a single mobile device. The number of people is not restricted and many people can be recorded at once. Any people or objects in the camera's field of vision will be captured.

The prior art also shows that it is possible to identify individual persons or objects from a large number of objects in an image. For example, people can be stored in a database, a photo is taken of these people and then this photo is compared to the recorded data. If there is a match, information can then be given indicating the specific location of a person.

The prior art also shows the ability to perform facial recognition in such a way that faces are recognized in an image without them being stored in a database in advance. This is shown in common smartphones that mark a face on a photo with a rectangle. In this way, it is possible to determine the number of people in an image.

Further, the prior art shows the ability to carry out object recognition during autonomous driving by pointing the camera at the road ahead. This makes it possible to read traffic signs and interpret them in such a way that a speed limit, for example, can be read. Typically, there are only a few traffic signs in a car camera's field of vision, so there are no issues with the underlying hardware. This image information is evaluated within the car and the technical issue of excessive data volumes does not arise. This scenario also typically suggests a passive camera, which only captures the traffic signs and then these traffic signs are interpreted.

The prior art is confronted with the problem that a potentially high number of people or objects to be recognized can be present within an image source. The hardware capacities of mobile devices, in particular, are limited and often the bandwidth is also limited. The disadvantage of the prior art is that extensive image data often cannot be transmitted to a remote server. If, on the other hand, the data is processed in the mobile device itself, extensive hardware capacities are required within the mobile device. Hardware capacities here refer to the processor performance and the size and speed of the memory.

In addition, an issue with the state of the art is that the battery power is heavily used and, especially with extensive image data, this can lead to heating within the end device and a reduction in battery life.

The aforementioned problems are exacerbated by the fact that image processing typically has a real-time requirement, i.e. from the user's subjective point of view, processing must take place immediately. Moving a camera, in particular, generates a large volume of image data, which must then be processed immediately.

### SUMMARY

Accordingly, it is an object of the present disclosure to propose a method which enables a user to have persons or objects displayed on their mobile device in real time, with which he can make contact with little technical effort. An objective here is that the hardware requirements are so low that even a mobile device has the capacity for this. Furthermore, it is an object of the present disclosure to provide a correspondingly equipped device. In addition, a computer program product may be provided which contains control commands that implement the method or operate the proposed device.

Accordingly, a method for configuring a user's mobile terminal in a semi-automated setup of a communication channel is proposed. This continuously reads out at least one imaging sensor for detecting several potential communication partners, wherein, depending on a preset number of potential communication partners, the zoom factor of an imaging sensor, a magnification factor or a focal value of at least one sensor of the imaging sensors is set; enabling a selection of communication partners by means of provided registration information; and setting up a communication channel from a predefined set of communication partners. a focal value of at least one sensor of the imaging sensors is set; a selection of communication partners is enabled by means of the registration information provided; and a communication channel is set up from a predefined set of communication channels to a terminal of the communication partner in accordance with a stored terminal identification or user ID of an enabled communication partner as a function of a user input of the user's mobile terminal.

The magnification factor can be set physically on the camera or simulated by the program. If the hardware does not have a corresponding lens, a virtual screen section can be selected which is zoomed, i.e. enlarged. A simple digital camera without a zoom lens or a camera without a corresponding lens can also be operated in such a way that it only uses one image section in normal operation. This means that the screen section can also be enlarged virtually. This also means that the zoom factor or magnification factor can be adjusted using the program. Depending on the application, adjusting the magnification factor means enlarging or reducing the image section.

The proposed method configures the mobile device in such a way that the camera or imaging sensor is set. The mobile end device is, for example, a smartphone of a user who has been assisted in setting up a communication channel. This is semi-automated, as the user does not have to select from a predefined list, such as a phone book, but rather the user uses their end device to scan a crowd of people and thus also aligns the camera. The user is then shown potential communication partners and can then select these communication partners individually. For example, the user points the camera at a group of 20 people. It is possible that all 20 users are registered for the underlying service. If only 15 users are registered for the proposed service, the magnification factor, focal length or zoom factor is set so that the preset number of potential communication partners is displayed individually, i.e. exclusively. If the user has entered that they want to see five potential communication partners, the zoom factor is set so that only five people are displayed on the smartphone screen. These five people may or may not be registered with the underlying service. Potentially, all five people can have stored registration information or, for example, only three of the five people do. The registered persons within the group of five are then shown which communication partners can be contacted. The potential communication partners then become actual communication partners when the user selects an actual communication partner.

For example, the user is shown the three potential communication partners within the zoomed-in image and the faces are displayed using a rectangle. If there are five people in the image, but only three are registered, the user is shown a total of three rectangles on the faces of the respective potential communication partner. The user then taps on a rectangle and a communication channel is set up or established.

At least one imaging sensor is continuously read out to detect a number of potential communication partners so that the people can be detected. The camera of the mobile end device is activated and continuously captures an image. It is also possible to use several cameras whose images are combined. Image recognition can then be used to determine how many people or objects are in the respective image. The user aligns the camera and thus detects different numbers of communication partners. At this stage, these are still only potential communication partners. The camera image is therefore a continuous sequence of individual images that are analyzed.

The user has stored a number of potential communication partners in advance and it is precisely this number that is then displayed. For this purpose, the proposed method automatically sets the magnification factor, the focal length or the zoom factor of the imaging sensor.

Specifically, it is therefore possible that the user has specified five potential communication partners in advance, whereby the user only specifies the number. If the user now points their camera at a group of ten people, the image is adjusted so that only five people are in the image. Due to the dimensions of a smartphone screen, it is typically not possible to set the number of potential communication partners higher than ten. As the individual communication partners are displayed for selection and a rectangle is placed around these faces, for example, the number of potential communication partners is severely limited.

According to the methods and devices disclosed herein, it has been shown that the ideal number of potential communication partners is between three to ten for the present method. These can be displayed in such a way that the face is actually recognizable to the user, i.e. the persons are identifiable, and yet the persons or communication partners can be selected by means of manual input. Typically, the user taps on the screen and thus selects the communication partner, which is no longer possible if there are more than ten people.

This means that the screen dimensions are taken into account when controlling the camera or one or more sensors.

If the number of potential communication partners is displayed and the user moves their mobile device, the system branches back to the continuous readout step and the image section or zoom factor, magnification factor or focal length is set again. If, for example, only three instead of the desired five potential communication partners are displayed, the system zooms out until a number of five potential communication partners is displayed.

A selection of communication partners is then activated using the registration information provided. If, for example, five people are displayed as potential communication partners, but only three people have registered for the underlying service, only these three people will be activated. Activation here means activating the creation of a communication channel. A communication channel can therefore be established with these activated persons or objects. It is also possible to limit the number of potential communication partners so that only activated, i.e. registered persons or objects, are displayed. If, for example, five communication partners are displayed but only three people have registered, the zoom factor is set so that there are at least five activated or registered communication partners in the image to be processed.

The registration information can be provided in such a way that user data is stored on a remote server, indicating which person or object wants to be contacted. Contact information can also be stored for this purpose. For example, a user can register with a photo and then store an address for setting up a video channel. If the person in the image to be processed is now recognized using facial recognition, it can be indicated that a video channel can be set up.

The potential communication partner can therefore specify which communication channel they would like to use. For example, a telephone number can also be stored or alternatively a texting service that is used. The user carrying out the proposed procedure is then shown that a telephone call or a text conversation or chat is possible with a potential communication partner. The potential communication partner can be a person who is then addressed using their stored terminal device.

The proposed method generally refers to human users communicating with a technical device. For example, a user may be traveling in a car and the camera detects a certain number of license plates. The proposed method then adjusts the camera so that a certain number of license plates are visible. The user, in this case the driver, is then shown the license plate on a screen with the driver he wishes to communicate with. If, for example, a first driver and a second driver are registered using the proposed method, it is possible for the drivers to contact each other on the highway in such a way that the first driver is shown five other drivers on his head-up display. This comparison can take place by means of image recognition of the license plate. The first driver then submits a voice entry and selects the potential communication partner displayed. This potential communication partner then becomes the actual communication partner by providing a communication channel with this driver.

The registration information can also contain features about the potential communication partner. For example, the registration information can be used to enter data about the communication partner. A potential element of the registration information is a location identifier of a potential communication partner. This means that someone can indicate that they want to be contacted, but only by people who have a license plate number that corresponds to their own city. The registration information can therefore contain information that the driver only wants to communicate with people from a specific city. The corresponding service can be expanded as required and, for example, drivers can also set that only potential communication partners with a certain relationship status are shown to them. In this way, it is technically easy to get in touch with other people, even if only a limited amount of screen space is available. By setting the imaging sensors, it is ensured that only potential communication partners up to a certain number are displayed.

A particular advantage here is that the potential communication partners are recognized automatically and that the camera can then also be set automatically. This means that potential communication partners are displayed without any input from the user. All the user has to do is align their mobile device accordingly and a suitable image with communication partners is then displayed. The selection of which potential communication partner the user wants to contact is ultimately up to the user.

According to one embodiment of the present invention, several imaging sensors are read out and their images are displayed on a display unit. This has the advantage that a perspective representation or a three-dimensional representation can be displayed. In this way, the communication partners can be arranged spatially and a spatial image is created. In addition, further information can be added to the image, such as additional information about the communication partners and a highlighting of the communication partners. Typically, current mobile devices and cars have several cameras, which can then be combined.

According to a further embodiment of the present invention, the communication partners are detected according to the stored registration information, the stored image information, depending on a read-out position sensor, depending on an altimeter and/or depending on an air pressure sensor. This has the advantage that only those communication partners can be reached who are also registered using the registration information. Image information can then be compared with the actual image from the camera using face recognition or pattern matching, allowing a user to be identified. In addition, it is also possible to specify a position at which the communication partner is located. Spatial restrictions could be implemented here, for example by defining a radius. The geographical position of the user can also be determined by means of an altimeter and an air pressure sensor, whereby the air pressure sensor in turn provides information regarding the altitude. This makes it possible, for example, to restrict the geographical regions in which the communication partners are located. For example, only communication partners within a radius of 15 meters or a larger area will be relevant.

According to a further embodiment of the present invention, the preset number of potential communication partners is specified as a function of a resolution and/or a percentage screen occupancy of the display unit. This has the advantage that for each resolution of the mobile terminal device it is possible to specify how many communication partners are to be displayed. This makes it possible to leave enough space to display the communication partner in such a way that the user can actually identify and select them. In this way, a list can be created that shows different possible resolutions of the screen and/or camera and then each resolution is assigned a value that describes the number of potential communication partners. For example, with a standard screen resolution, five communication partners can be displayed. If the resolution is higher, a number of seven condition partners may also be possible. In this way, the camera is set so that it also takes the screen into account and then a suitable number of communication partners is always displayed. The percentage screen occupancy can also be defined in such a way that, for example, 15% of the screen is reserved for a communication partner. As 15% is no longer possible after 90%, only 90% of the screen occupancy is used and six communication partners are displayed. It is also possible to define 20% of the screen occupancy so that only five communication partners are displayed on the entire screen. The camera is set so that the focal length or zoom factor captures exactly this number of communication partners.

According to a further embodiment of the present invention, the number of potential communication partners is set with a selection from three to ten. This has the advantage that with typical screen dimensions of a smartphone, a number of communication partners can be displayed that allow the user to identify them and select them accordingly by means of touchscreen input. Surprisingly, it was found that this is a suitable number for selecting a communication partner with common camera configurations and screens. Empirically, it was determined that if the number of communication partners displayed exceeds ten, the display becomes confusing and that it is no longer technically possible to accurately select a communication partner using a touchscreen and finger input.

According to a further embodiment of the present invention, the magnification factor or zoom factor is set in such a way that the potential communication partners read out correspond exactly to the preset number of potential communication partners. This has the advantage that the camera is set with respect to the zoom factor in such a way that the captured image is reduced or enlarged until the preset number of communication partners is present in the image. The camera is therefore adjusted automatically.

According to a further embodiment of the present invention, the registration information comprises at least one image, at least one pattern, information on the license plate, a facial feature, biometric data and/or at least one visual user identification. This has the advantage that the existing communication partners can be compared with a stored image. If there is a sufficient match, it is then assumed that the person in the stored image is actually in the captured real-time image. If a communication partner is not a person, a pattern can also be stored, which can be captured easily by using image recognition. Parts of or a complete license plate can also be optically stored so that a car can be selected as the communication partner. If you want to send a warning, for example, a driver can enter their license plate information in text form as registration information and then other drivers can select precisely this car and the driver of this car receives a warning on their display.

According to a further embodiment of the present invention, the set of communication channels comprises an audio channel, a video channel and/or a textual communication channel. This has the advantage that the user can choose from several formats and can thus set the appropriate communication channel. A communication channel can be a textual conversation, i.e. a chat, or an audio-visual message exchange.

According to a further embodiment of the present invention, the terminal device identifier or user identifier comprises an address, a telephone number, contact data and/or an alphanumeric character string. This has the advantage that the terminal device can be addressed in different ways and, in addition, different terminal device identifiers can also be present. In addition to a telephone number, an address can also be stored for video communication. The user can then select how the communication channel is to be established.

According to a further embodiment of the present invention, the user input of the mobile terminal device takes place by means of touching a touch-sensitive display unit and/or by means of voice input. This has the advantage that the user can either select his communication partner on his display or he can enter voice input in a car and then he can specify which of the communication partners is to be selected.

According to a further embodiment of the present invention, the user's mobile terminal device is in the form of a telephone, electronic glasses with a user interface and/or a head-up display. This has the advantage that different hardware can be used. For example, a user can use electronic glasses that can display information in the lens of the glasses. In this way, the user receives different information about the communication partners surrounding them. Further information can be used to show which communication partners are registered. In addition, it is often possible to show a camera image in a display inside the glasses, which then zooms in or out on the communication partners in the desired factor.

According to a further embodiment of the present invention, the communication channel is established using Bluetooth, WLAN, an air interface of a mobile phone network, a point-to-point connection and/or a telephone connection. This has the advantage that different communication technologies can be used and a second communication technology can be used if a first communication technology fails. These technologies can also be prioritized and if a high-priority technology fails, a lower-priority technology is automatically substituted.

The described objective is also solved by a device for configuring a mobile terminal of a user in a semi-automated setup of a communication channel, comprising a readout unit set up for continuously reading out at least one imaging sensor for detecting a number of potential communication partners, wherein a magnification factor of at least one sensor of the imaging sensors is set by means of a configuration unit as a function of a preset number of potential communication partners; an enabling unit set up for enabling a selection of communication partners by means of provided registration information; and a communication interface set up for setting up a communication channel from a predefined number of communication channels to a terminal device of the communication partner in accordance with a stored user ID or terminal device ID of an enabled communication partner. The terminal device identifier of an enabled communication partner depending on the user input of the user's mobile terminal device.

The magnification factor and zoom factor can be used synonymously here.

The objective is also solved by a computer program product with control commands that implement the proposed method or operate the proposed device.

According to the embodiments of the invention provided, it is particularly advantageous that the method can be used to operate the proposed devices and units. Furthermore, the proposed devices and units are suitable for carrying out the method. Thus, in each case the device implements structural features which are suitable for carrying out the corresponding method. However, the structural features can also be designed as process steps. The proposed method also provides steps for implementing the function of the structural features. In addition, physical components can also be provided virtually or virtualized.

### BRIEF DESCRIPTION OF THE DRAWINGS

Further advantages, features and details of the invention are apparent from the following description, in which aspects of the invention are described in detail with reference to the figures. The features mentioned in the claims and in the description may each be essential to the invention individually or in combination with each other. Likewise, the above-mentioned features and the features further described herein may be used individually or in combination with each other. Functionally similar or identical parts or components are sometimes provided with the same reference signs. The terms “left”, “right”, “top” and “bottom” used in the description of the embodiments refer to the figures in an orientation with legible figure designations or legible reference signs. The embodiments shown and described are not definitive, but are used as examples to explain the invention. The detailed description is for the information of the person skilled in the art, therefore known circuits, structures and methods are not shown or explained in detail in the description so as not to impede the understanding of the present description. The figures show:

FIG. 1 provides a schematic flowchart of the proposed method for configuring a mobile terminal of a user in a semi-automated setup of a communication channel according to one embodiment of the present invention;

FIG. 2 shows the field of vision starting from the user and showing that the field of vision is divided horizontally and vertically, according to an embodiment of the present invention; and

FIG. 3 shows the field of vision starting from the user according to one embodiment of the present invention.

### DETAILED DESCRIPTION

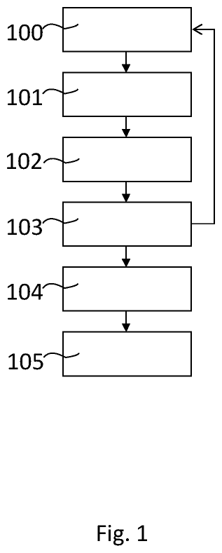

FIG. 1 shows a schematic flow chart with a method for configuring a mobile terminal of a user in a semi-automated setup of a communication channel, comprising a continuous readout 100 of at least one imaging sensor for detecting 102 a number of potential communication partners, wherein a magnification factor of at least one sensor of the imaging sensors is set 103 depending on a preset 101 number of potential communication partners; enabling 104 a selection of communication partners by means of the provided registration information; and setting up 105 a communication channel from a predefined number of communication channels to a terminal of the communication partner according to the stored terminal identification of an enabled 104 communication partner depending on the user input of the user's mobile terminal.

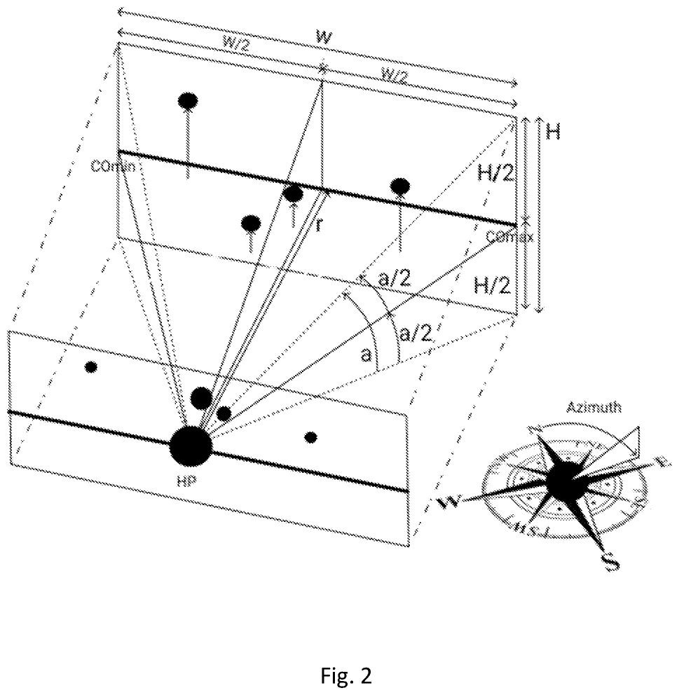

FIG. 2 shows the field of vision starting from the user at the bottom and shows that the field of vision is divided horizontally and vertically. The virtual center line corresponds to the azimuth angle, i.e. the angle relative to the north pole. The direction of the compass is determined using the magnetometer or compass. The horizontal center line is determined by the vertical orientation of the phone, which is determined using rotation sensors and/or tilt sensors.

Whereby
W=width of the field of vision
W/2=half the width of the field of vision
H=Height of the field of vision
H/2=half the height of the field of vision
r=Distance to camera or home position (field of vision radius)
a=vertical aperture angle of the camera
a/2=half the vertical aperture angle of the camera
b=horizontal aperture angle of the camera
b/2=half the horizontal aperture angle of the camera
COmin=Geo coordinate minimum
COmax=Geo coordinate maximum
HP=Home Position

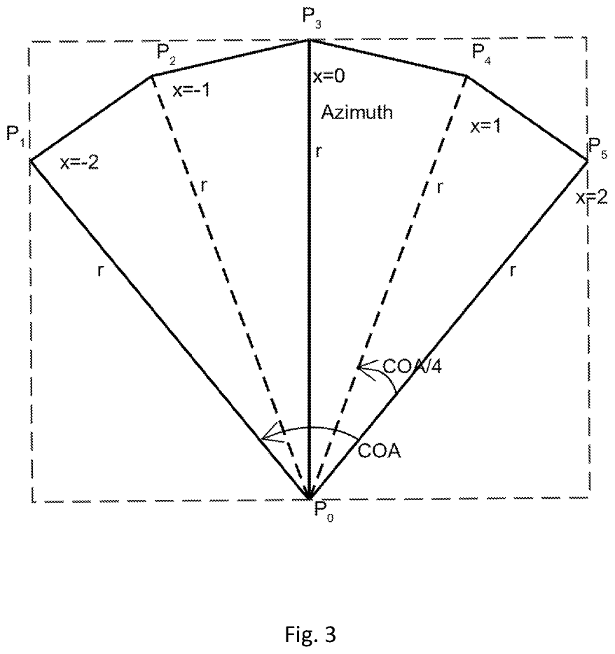

FIG. 3 shows the field of vision starting from the user. To speed up data storage, the field of vision is shown as a closed polygon. The accuracy of altitude information from a GPS signal is highly dependent on the quality of the received signal and the number of satellites received. If available, the signal from the air pressure sensor, a barometer, is used to improve the altitude information. As the air pressure at the target's location is also known, its altitude can now be calculated in relation to your own altitude using the air pressure. This requires the transmission of sensor data, such as air pressure and temperature, as well as GPS position and signal quality to the server.

Whereby
P0=Home position
P1 . . . 5=Geo coordinates at distance r and angle (COA/4*X) from P0 (Calculation according to WGS84 georeference system)
r=field of vision radius
X=Coordinates index
Azimuth=Azimuth angle
COA=horizontal camera aperture angle
COA/4=¼ of the horizontal camera aperture angle

Calculation of the polygon coordinates:

P_{n[1 . . . 5]}=P₀·at(r,Azimuth+[x_{[-2 . . . 2]}*COA/4])

The function “at( )”1) calculates the coordinate starting from point P0 at a distance of r and an azimuth angle according to the WGS84 Georeference System.

Polygon={P₀,P_{n[n=1 . . . 5]},P₀}

Not shown here is a data memory or a computer-readable medium with a computer program product comprising control instructions which implement the proposed method or operate the proposed system arrangement.

What is claimed is:

1. A method for configuring a mobile terminal of a user in a semi-automated setup of a communication channel, comprising:
a continuous readout (100) of at least one imaging sensor for detecting (102) a number of potential communication partners, wherein a magnification factor of at least one sensor of the imaging sensors is set (103) as a function of a preset (101) number of potential communication partners, wherein the preset number of potential communication partners is specified depending on the resolution of the display unit and a percentage screen occupancy of the display unit;
an enabling (104) of a selection of communication partners by means of a provided registration information; and
setting up (105) a communication channel from a predefined number of communication channels to a terminal device of the communication partner in accordance with a stored terminal device identifier of an enabled (104) communication partner depending on the user input of the user's mobile terminal device.

2. The method of claim 1, wherein several imaging sensors are read out and their images are displayed in combination on a display unit.

3. The method of claim 1, wherein the communication partners are detected as a function of stored registration information, stored image information, as a function of a read-out position sensor, as a function of an altimeter and/or as a function of an air pressure sensor.

4. The method of claim 1, wherein the number of potential communication partners is set with a selection from three to ten.

5. The method of claim 1, wherein the magnification factor is set in such a way that the potential communication partners read out corresponds exactly to the preset number of potential communication partners.

6. The method of claim 1, wherein the registration information comprises at least one image, at least one pattern, information from a license plate, a facial feature, biometric data and/or at least one visual user ID.

7. The method of claim 1, wherein the number of communication channels comprises an audio channel, a video channel and/or a textual communication channel.

8. The method of claim 1, wherein the terminal device identifier comprises an address, a telephone number, a user identity, contact data and/or an alphanumeric character string.

9. The method of claim 1, wherein the user input of the mobile terminal device takes place by means of touching a touch-sensitive playback unit and/or by means of voice input.

10. The method of claim 1, wherein the user's mobile terminal device is in the form of a telephone, electronic glasses with a user interface and/or a head-up display.

11. The method of claim 1, wherein the communication channel can be established using Bluetooth, WLAN, an air interface of a mobile radio network, a point-to-point connection, a WIFI direct connection and/or a direct WLAN connection.

12. A device for configuring a mobile terminal of a user in a semi-automated setup of a communication channel, comprising:
a readout unit set up for continuous readout (100) of at least one imaging sensor for detecting (102) a number of potential communication partners, a magnification factor of at least one sensor of the imaging sensors being set (103) by means of a configuration unit as a function of a preset (101) number of potential communication partners;
an enabling unit arranged for enabling (104) a selection of communication partners by means of the provided registration information; and
a communication interface for setting up (105) a communication channel from a predefined number of communication channels to the terminal device of the communication partner in accordance with the stored terminal device identifier of an enabled (104) communication partner depending on a user input of the user's mobile terminal device; wherein the preset number of potential communication partners is specified depending on the resolution of the display unit and a percentage screen occupancy of the display unit.

13. A computer program product comprising instructions which, when the program is executed by at least one computer, instruct the computer to perform the steps of the method of claim 1.

14. A computer-readable storage medium comprising instructions which, when executed by at least one computer, instruct the computer to perform the steps of the method of claim 1.
